(19) United States
(12) Patent Application Publication
(10) Pub. No.: US 2025/0390928 A1
(43) Pub. Date: Dec. 25, 2025

(54) RECOMMENDING CONTENT BASED ON A PREDICTED EXPLORATION SCORE FOR AN ONLINE SYSTEM USER

(71) Applicant: Maplebear Inc., San Francisco, CA (US)

(72) Inventors: Brent Scheibelhut, Toronto (CA); Kylie Moses, Medina, WA (US); Naval Shah, Toronto (CA); Mark Oberemk, Toronto (CA); Madeline Mesard, New York, NY (US); Charles Wesley, San Diego, CA (US)

(21) Appl. No.: 18/753,912

(22) Filed: Jun. 25, 2024

(51) Int. Cl. G06Q 30/0601; G06N 20/00

(52) U.S. Cl. CPC G06Q 30/0631; G06N 20/00; G06Q 30/0633

(57) ABSTRACT

An online system retrieves a set of user data including information describing one or more interactions by a user with the system. The system accesses and applies a machine-learning model to predict an exploration score for the user based on the set of user data, in which the score describes a likelihood of a set of interactions by the user with content associated with less than a threshold measure of familiarity to the user. Upon receiving a request from a client device associated with the user to access a user interface including content recommended to the user, the system selects content to recommend to the user based on the score and information describing a set of previous interactions by the user with the content. The system generates the user interface including the selected content and sends the user interface to the client device where it is displayed.

### BACKGROUND

Online systems, such as online concierge systems, social networking systems, video sharing websites, etc., may present their users with various types of content with which the users may interact. For example, users may place orders including items presented to them by online concierge systems, connect and communicate with other users on social networking systems, view videos on video sharing websites, etc. To encourage user engagement, online systems may recommend content to their users, such as content similar to that with which the users previously interacted. For example, if a user of an online system previously added a leather jacket to a list of their favorite items, the online system may recommend similar items to the user, such as other leather jackets of the same color, style, brand, etc.

However, depending on the willingness of online system users to explore new content, some users may be less inclined to interact with recommended content. For example, suppose that a user saves a recipe for a Chinese noodle dish on a recipe sharing website and then prepares the recipe. In this example, if the user is interested in different types of foods or cuisines and similar recipes, such as recipes for other Chinese dishes or other noodle dishes are recommended to them the next time they visit the website, the user may not be interested in these recipes and may not interact with any of them. Therefore, online system users who are more willing to explore new content may lose interest in online systems and may reduce their engagement with the online systems or even stop using them altogether if they have no interest in content that is recommended to them.

### SUMMARY

In accordance with one or more aspects of the disclosure, an online system recommends content based on a predicted exploration score for a user of the online system. More specifically, an online system retrieves a set of user data, in which the set of user data includes information describing one or more interactions by a user with the online system. The online system accesses and applies a machine-learning model to predict an exploration score for the user based on the set of user data, in which the exploration score describes a likelihood of a set of interactions by the user with content associated with less than a threshold measure of familiarity to the user. Upon receiving a request from a client device associated with the user to access a user interface including content recommended to the user, the online system selects a set of content to recommend to the user based on the exploration score for the user and information describing a set of previous interactions by the user with the set of content. The online system then generates the user interface including the selected set of content and sends the user interface to the client device, causing the client device to display the user interface.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is a flowchart of a method for recommending content based on a predicted exploration score for a user of an online system, in accordance with one or more embodiments.

FIGS. 4-7B illustrate examples of a user interface including a set of content recommended to a user of an online system, in accordance with one or more embodiments.

### DETAILED DESCRIPTION

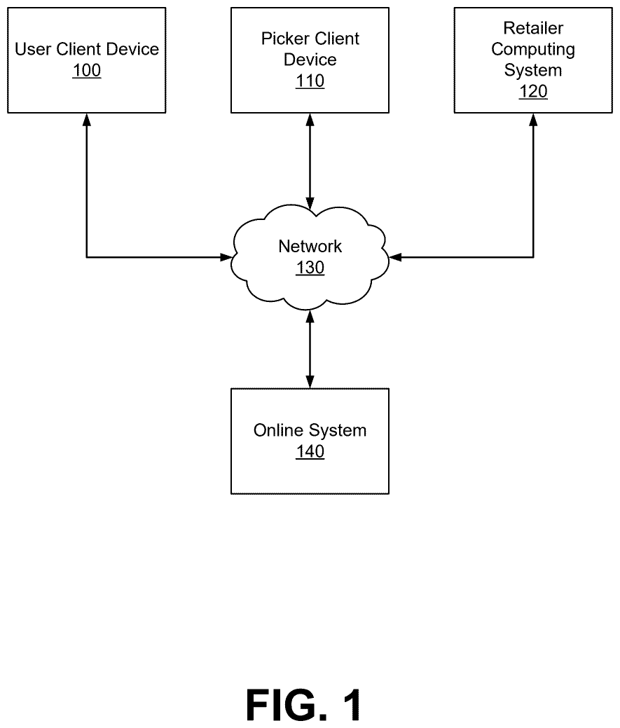

FIG. 1 illustrates an example system environment for an online system, in accordance with one or more embodiments. The system environment illustrated in FIG. 1 includes a user client device 100, a picker client device 110, a retailer computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online system 140. As such, there may be more than one user client device 100, picker client device 110, or retailer computing system 120.

The user client device 100 is a client device through which a user may interact with the picker client device 110, the retailer computing system 120, or the online system 140. The user client device 100 may be a personal or mobile computing device, such as a smartphone, a tablet, a laptop computer, or a desktop computer. The user client device 100 also may be a smart shopping cart, which may include a wheeled cart, a shopping basket, etc. that may be used to carry items collected by the user. The smart shopping cart also may include a display area, various sensors (e.g., a scale, cameras, microphones, GPS sensors, etc.), speakers, buttons, or any other suitable components. Sensors of the smart shopping cart may have capabilities to identify items or other physical objects or to determine their attributes. For example, sensors of the smart shopping cart may include interior-facing cameras that capture images or videos of items placed in the smart shopping cart, as well as exterior-facing cameras that capture images or videos of items or other objects located elsewhere at a retailer location. In this example, computer-vision techniques may be applied to the images or videos to identify the items in the smart shopping cart or to identify items or other objects within a threshold distance of the smart shopping cart depicted by the images/videos. In the above example, the sensors of the smart shopping cart also may include a laser sensor or an ultrasonic sensor that determines one or more dimensions of each item and a scale that determines the weight of each item in the smart shopping cart. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, refers to a good or product that may be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user may use to place an order with the online system 140. The ordering interface may be part of a client application operating on the user client device 100. The ordering interface allows the user to search for items that are available through the online system 140 and the user may select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the items should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

One or more sensors of a user client device 100 associated with a user may collect contextual information associated with the user during a shopping session at a retailer location. Contextual information may only be collected if a user has previously explicitly consented to the collection of contextual information associated with the user during the user's shopping session. Contextual information may describe a set of items collected by a user (e.g., items within a shopping basket being used by the user), a state of the user (e.g., whether the user is moving or stationary), a velocity or an orientation of the user, a location associated with the user (e.g., in a department or at a checkout stand or a sample kiosk within a retailer location), etc. Contextual information may include image data, video data, audio data, etc. that may be collected by one or more sensors of a user client device 100 associated with a user. For example, contextual information associated with a user may include images or videos depicting items added to a smart shopping cart being used by the user. In this example, the contextual information also may include a location associated with the user within a retailer location (e.g., a location of a user client device 100 associated with the user), such as an aisle, a department, or a sample kiosk within the retailer location, and attributes (e.g., a brand, a dimension, a weight, etc.) of each item. Contextual information also may be associated with various types of information, such as a name of a retailer that operates a retailer location at which the contextual information was collected, a geographical location associated with the retailer location, a time at which the contextual information was collected, information identifying a user or a purchase associated with the contextual information, etc. Once collected by a user client device 100, contextual information may be transmitted to the online system 140 via the network 130.

The picker client device 110 is a client device through which a picker may interact with the user client device 100, the retailer computing system 120, or the online system 140. The picker client device 110 may be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer location. The picker client device 110 presents the items that are included in the user's order to the picker in a collection interface. The collection interface is a user interface that provides information to the picker identifying items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer location, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker may use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 provides instructions to a picker for delivering the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140. Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online system 140. As used herein, a “retailer” is an entity that operates a “retailer location,” which is a store, a warehouse, a building, or other location from which a picker can collect items or from which a user may order or purchase items. The retailer computing system 120 stores and provides item data to the online system 140 and may regularly update the online system 140 with updated item data. For example, the retailer computing system 120 provides item data indicating which items are available at a particular retailer location and the quantities of those items. Additionally, the retailer computing system 120 may transmit updated item data to the online system 140 when an item is no longer available at the retailer location. Furthermore, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The user client device 100, the picker client device 110, the retailer computing system 120, and the online system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

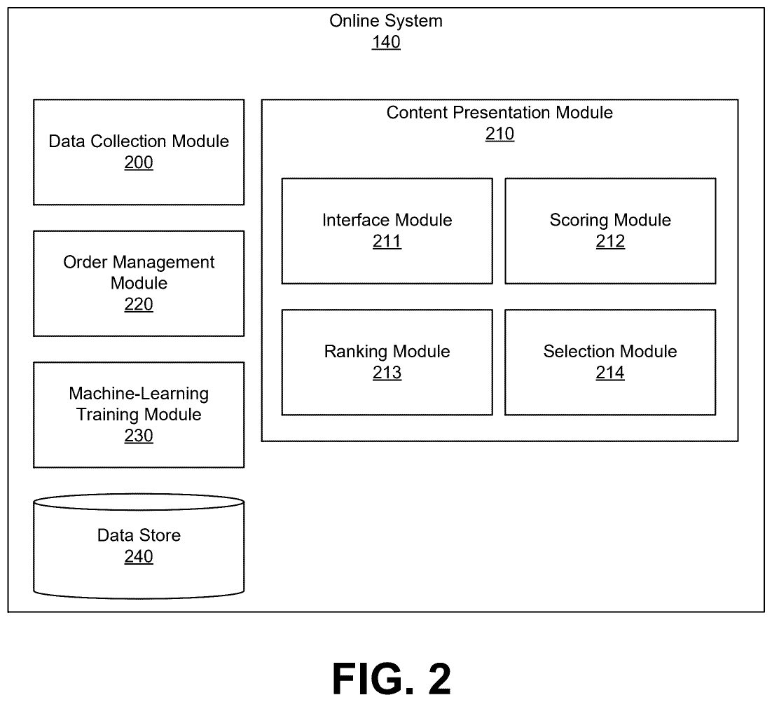

The online system 140 may be an online concierge system by which users can order items to be provided to them by a picker from a retailer. The online system 140 receives orders from a user client device 100 through the network 130. The online system 140 selects a picker to service the user's order and transmits the order to a picker client device 110 associated with the picker. The picker collects the ordered items from a retailer location and delivers the ordered items to the user. The online system 140 may charge a user for the order and provide portions of the payment from the user to the picker and the retailer. As an example, the online system 140 may allow a user to order groceries from a grocery store retailer. The user's order may specify which groceries they want delivered from the grocery store and the quantities of each of the groceries. The user's client device 100 transmits the user's order to the online system 140 and the online system 140 selects a picker to travel to the grocery store retailer location to collect the groceries ordered by the user. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

The data collection module 200 collects user data, which is information or data describing characteristics of a user. User data may include a user's name, address, shopping preferences (e.g., preferred or favorite retailer locations or items), dietary restrictions/preferences, or stored payment instruments. User data also may include a user's interests or hobbies, as well as demographic information associated with the user (e.g., age, gender, geographical region, educational background, occupation, etc.) or household information associated with the user (e.g., a number of people in the user's household, whether the user's household includes children or pets, etc.). The user data also may include default settings established by the user, such as a default retailer/retailer location, payment instrument, delivery location, or delivery timeframe. In some embodiments, user data also includes an exploration score for a user. An exploration score for a user describes a likelihood of a set of interactions by the user with content associated with less than a threshold measure of familiarity to the user, as further described below. An exploration score for a user may be received from a user client device 100 associated with the user (e.g., in a response to a survey, a questionnaire, etc. sent to the user client device 100) or determined by a human or automatically without human intervention (e.g., using a set of heuristic techniques). An exploration score also may be predicted, as further described below. In some embodiments, an exploration score for a user is specific to one or more attributes associated with content that may be presented to the user. For example, an exploration score for a user may be specific to a particular item category. Furthermore, in some embodiments, user data includes multiple exploration scores for a user. In the above example, a set of user data for the user may include multiple exploration scores for the user, in which each exploration score is specific to a different item category.

User data further may include historical information associated with a user, such as historical conversion information or historical interaction information. For example, user data may include historical conversion information, such as historical order information associated with a user describing previous orders placed by the user or historical purchase information associated with the user describing previous purchases made by the user. In this example, the historical order information may describe one or more items included in each order (e.g., an item category, a size, a brand, a quantity, a price, etc. associated with each item), a time each order was placed, a retailer location from which the item(s) included in each order was/were collected, etc. Similarly, in this example, the historical purchase information may describe one or more items included in each purchase, a time each purchase was made, a retailer location from which each purchase was made, etc. As an additional example, user data may include historical interaction information describing previous interactions by a user with various types of content (e.g., items, recipes, coupons, advertisements, social media posts, images, videos, audio files, etc.) presented by the online system 140. In this example, the historical interaction information may describe the content, a type of each interaction (e.g., adding an item to a shopping list, saving a recipe, etc.), a time or a duration of each interaction, or a type of social proof (e.g., ratings, reviews, certifications, testimonials, endorsements, etc.) associated with the content, if any.

User data also may include additional types of historical information associated with a user, such as historical location information, historical contextual information, or any other suitable types of historical information. For example, user data may include historical location information, such as information describing countries, states, cities, towns, restaurants, stores, etc., previously associated with a user. In this example, the user data also may include historical contextual information collected during the user's previous shopping sessions at retailer locations, including information describing aisles, departments, or kiosks within the retailer locations previously associated with the user. In the above example, the user data also may describe previous interactions by the user with items at each retailer location, such as information describing the items, the types of interactions (e.g., picking up an item, adding an item to a shopping cart, sampling an item, etc.), a time of each interaction, etc. The data collection module 200 may collect the user data from sensors on the user client device 100 or based on the user's interactions with the online system 140. The data collection module 200 also may collect the user data from other components of the online system 140.

The data collection module 200 also collects item data, which is information or data identifying and describing items that are available at a retailer location. The item data may include item identifiers for items that are available and may include quantities of items associated with each item identifier. Additionally, item data may also include attributes of items such as the sizes, colors, weights, stock keeping units (SKUs), serial numbers, prices, item categories, brands, qualities (e.g., freshness, ripeness, etc.), ingredients, materials, manufacturing locations, versions/varieties (e.g., flavors, low fat, gluten-free, organic, etc.), availabilities/seasonalities, or any other suitable attributes of the items. The item data also may include information describing locations associated with items within a retailer location. For example, item data may include information describing an aisle number and a shelf within a retailer location associated with an item. In some embodiments, information describing a location associated with an item within a retailer location includes a layout of the retailer location that describes an arrangement of aisles, departments, display tables or cases, etc. at the retailer location. In the above example, the aisle and shelf may be indicated on an image corresponding to a layout of the retailer location. Item data also may include various types of social proof associated with items, such as ratings, reviews, certifications, testimonials, endorsements, etc. associated with the items. The item data may further include purchasing rules associated with each item, if they exist. For example, age-restricted items such as alcohol and tobacco are flagged accordingly in the item data. Additionally, item data may include information describing a time that an item first became available at a retailer location. Item data may also include information that is useful for predicting the availability of items at retailer locations. For example, for each item-retailer combination (a particular item at a particular retailer location), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or a user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. In some embodiments, item categories may be broader in that the same item category may include item types that are related to a common theme, found in the same department, etc. For example, items such as apples, oranges, lettuce, and cucumbers may be included in a “produce” item category. As an additional example, items such as garlic bread, pasta, and alfredo sauce may be included in an “Italian cuisine” item category, while items such as soy sauce and kimchi may be included in a “Asian foods” item category. Furthermore, in various embodiments, an item may be included in multiple categories. For example, croissants may be included in a “croissant” item category, a “pastry” item category, and a “bakery” item category. The item categories may be human-generated and human-populated with items. The item categories also may be generated automatically by the online system 140 (e.g., using a clustering algorithm).

The data collection module 200 also collects picker data, which is information or data describing characteristics of pickers. For example, the picker data for a picker may include the picker's name, the picker's location, how often the picker has serviced orders for the online system 140, a user rating for the picker, the retailers from which the picker has collected items, or the picker's previous shopping history. Additionally, the picker data may include preferences expressed by the picker, such as their preferred retailers for collecting items, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects conversion data, which is information or data describing characteristics of an order or a purchase. For example, conversion data may include item data for items that are included in an order, a delivery location for the order, a user associated with the order, a retailer location from which the user wants the ordered items collected, or a timeframe within which the user wants the order delivered. As an additional example, conversion data may include item data for items that are included in a purchase, user data for a user who made the purchase, and information describing the purchase (e.g., a retailer location from which the user purchased the items and a date and a time of the purchase). Conversion data may further include information describing how an order was serviced, such as which picker serviced the order, when the order was delivered, or a rating that the user gave the delivery of the order. Conversion data also may include user data for users associated with orders or purchases, such as user data for a user who placed an order or made a purchase or picker data for a picker who serviced an order.

The data collection module 200 also may collect recipe data, which is information or data describing characteristics of a recipe. Recipe data may include information that may be used to identify a recipe, such as a name of the recipe, an author of the recipe, a date the recipe was created, one or more images or videos associated with the recipe, etc. Recipe data also may include information describing a set of items associated with preparing a recipe, such as information describing a set of items corresponding to a set of ingredients of the recipe (e.g., information describing each ingredient, an amount or a quantity of each ingredient, etc.) or information describing a set of tools used to prepare the recipe, such as aluminum foil, a rolling pin, a food processor, etc. Recipe data also may include a set of instructions for preparing a recipe, an amount of time required to prepare the recipe, a set of nutritional information associated with the recipe, a number of servings the recipe yields, a cuisine associated with the recipe, or a meal (e.g., brunch, dessert, etc.) associated with the recipe. Recipe data also may include various types of social proof associated with a recipe, such as a rating for the recipe or reviews, certifications, testimonials, endorsements, etc. associated with the recipe. Furthermore, recipe data may include text data, image data, video data, audio data, or any other suitable types of data.

In some embodiments, the data collection module 200 also collects additional data, which may describe characteristics of an image, a video, an audio file, a social media post, an advertisement, a coupon, or any other suitable types of content that may be presented to a user of the online system 140. This data may include text data, image data, video data, audio data, or any other suitable types of data. Furthermore, this data may include information that may be used to identify the content, attributes of the content, or any other suitable types of information associated with the content. For example, data collected by the data collection module 200 may include a video, a title of the video, a name of an entity (e.g., a brand, a musician, etc.) associated with the video, a name of a user who provided the video to the online system 140, a date the video was provided to the online system 140, a category associated with the video (e.g., tutorial, music video, etc.), a length of the video, etc. In this example, the data also may include information describing any tags associated with the video or any types of social proof associated with the video, such as a number of users who viewed, saved, or shared the video, a number of users who expressed a preference for the video, a number of users who expressed a dislike for the video, etc.

The data collection module 200 also may derive information from other data stored in the data store 240 and store this derived information in the data store 240 (e.g., in association with the data from which it was derived). For example, based on user data describing previous conversions by users of the online system 140, the data collection module 200 may derive a number of conversions by a user associated with one or more attributes (e.g., an item category, a brand, a weight, a user rating, etc. associated with an item), an average number of conversions by users of the online system 140 associated with the attribute(s), and a ratio of the former to the latter. As an additional example, based on user data describing previous interactions by users of the online system 140 with various items or recipes, the data collection module 200 may derive a number of interactions by a user associated with an item or a recipe, an average number of interactions by users associated with the item or the recipe, and a ratio of the former to the latter. As another example, based on user data describing locations (e.g., countries, retailer locations, aisles within retailer locations, etc.) previously associated with a user, the data collection module 200 may derive information describing the user's visit to each location (e.g., a time of each visit, a duration of each visit, a number of visits to each location, etc.).

The following illustrate additional examples of information the data collection module 200 may derive from other data stored in the data store 240 and which the data collection module 200 may subsequently store in the data store 240. Suppose that a set of user data describes previous purchases made by a user from a retailer location, interactions by the user with items at the retailer location, such as picking up items, sampling items, adding items to a shopping cart, etc., and aisles, departments, or kiosks within the retailer location the user visited. In this example, based on the user data, the data collection module 200 may derive a number of items the user purchased after sampling them, an amount of time elapsed between a time that the user picked up an item at the retailer location and added the item to a shopping cart, a route taken by the user each time they visited the retailer location, or an amount of time the user spent in each aisle, department, or kiosk. In this example, based on item data describing a time that an item the user purchased first became available at the retailer location, the data collection module 200 also may derive an amount of time elapsed between the time the item first became available at the retailer location and a time of the purchase.

In some embodiments, information the data collection module 200 derives from other data stored in the data store 240 and stores in the data store 240 is associated with a measure of uniqueness of a set of items (e.g., a set of items included in a shopping list, an order, a purchase, etc.). A measure of uniqueness of a set of items may be derived based on a number or a percentage of the set of items associated with one or more unique attributes (e.g., item categories, brands, etc.) or based on any other suitable criteria. For example, the data collection module 200 may derive a measure of uniqueness of a set of items included in a shopping list that is proportional to a number of items associated with different item categories included in the shopping list. In this example, if the shopping list only includes items associated with a single item category (e.g., different flavors, brands, etc. of items included in a “frozen pizza” item category), the data collection module 200 may derive a low measure of uniqueness of the set of items included in the shopping list. Alternatively, in the above example, if the shopping list includes items associated with several item categories (e.g., “fresh apple,” “frozen broccoli,” “ground coffee,” “aluminum foil,” “orange juice,” “egg,” “milk,” “disinfecting wipe,” “diaper,” “cat food,” “shampoo,” “balloon,” “magazine,” and “gift card”), the data collection module 200 may derive a high measure of uniqueness of the set of items included in the shopping list. As an additional example, if the data collection module 200 derives a measure of uniqueness of a set of items included in a shopping list associated with a user and an average measure of uniqueness of items included in shopping lists associated with users of the online system 140, the data collection module 200 also may derive a ratio of the former to the latter.

The content presentation module 210 selects content for presentation to a user. For example, the content presentation module 210 selects which items to present to a user while the user is placing an order. Components of the content presentation module 210 include: an interface module 211, a scoring module 212, a ranking module 213, and a selection module 214, which are further described below.

The interface module 211 generates and transmits an ordering interface for the user to order items. The interface module 211 populates the ordering interface with items that the user may select for adding to their order. In some embodiments, the interface module 211 presents a catalog of all items that are available to the user, which the user can browse to select items to order. Other components of the content presentation module 210 may identify items that the user is most likely to order and the interface module 211 may then present those items to the user. For example, the scoring module 212 may score items and the ranking module 213 may rank the items based on their scores. In this example, the selection module 214 may select items with scores that exceed some threshold (e.g., the top n items or the p percentile of items) and the interface module 211 then displays the selected items.

The scoring module 212 may use an item selection model to score items for presentation to a user. An item selection model is a machine-learning model that is trained to score items for a user based on item data for the items and user data for the user. For example, the item selection model may be trained to determine a likelihood that the user will order an item. In some embodiments, the item selection model uses item embeddings describing items and user embeddings describing users to score items. These item embeddings and user embeddings may be generated by separate machine-learning models and may be stored in the data store 240.

In some embodiments, the scoring module 212 scores items based on a predicted availability of an item. The scoring module 212 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The scoring module 212 may apply a weight to the score for an item based on the predicted availability of the item. Alternatively, an item may be filtered out from presentation to a user by the selection module 214 based on whether the predicted availability of the item exceeds a threshold.

In some embodiments, the scoring module 212 scores content (e.g., items, recipes, coupons, advertisements, images, videos, audio files, social media posts, etc.) based on a search query received from the user client device 100. A search query is free text for a word or set of words that indicate content of interest to the user. The scoring module 212 scores content based on a relatedness of the content to the search query. For example, the scoring module 212 may apply natural language processing (NLP) techniques to the text in the search query to generate a search query representation (e.g., an embedding) that represents characteristics of the search query. The scoring module 212 may use the search query representation to score candidate content for presentation to a user (e.g., by comparing a search query embedding to an embedding for the content).

The scoring module 212 also may retrieve a set of user data for a user. The set of user data may include historical information associated with the user, such as historical interaction information describing one or more previous interactions by the user with the online system 140. For example, the set of user data retrieved by the scoring module 212 may describe previous interactions by the user with content (e.g., items, recipes, coupons, advertisements, images, videos, audio files, social media posts, etc.) presented by the online system 140. In this example, the set of user data may describe the content (e.g., a type of the content, one or more attributes of the content, etc.), a type of each interaction, a time or a duration of each interaction, a type of social proof associated with the content (if any), etc. The set of user data retrieved by the scoring module 212 also may include additional types of historical information associated with the user, such as historical conversion, contextual, or location information associated with the user. Additionally, the set of user data retrieved by the scoring module 212 may include information describing the user's shopping or dietary preferences, demographic or household information associated with the user, information describing the user's interests or hobbies, information derived from other user data for the user, or any other suitable types of information.

In some embodiments, the scoring module 212 also retrieves additional types of data from the data store 240. Examples of such types of data include: item data, recipe data, or data for any other types of content stored in the data store 240. For example, the scoring module 212 may retrieve a set of item data for each item a user previously ordered or purchased, such as information describing an item category associated with the item, a brand or a size of the item, ingredients of the item, etc. As an additional example, the scoring module 212 may retrieve a set of recipe data for each recipe a user previously saved, such as a name of the recipe, information describing ingredients of the recipe, information describing a cuisine associated with the recipe, etc.

The scoring module 212 also may predict an exploration score for a user describing a likelihood of a set of interactions by the user with content associated with less than a threshold measure of familiarity to the user. An exploration score may correspond to a value, such as a number or a percentage. For example, suppose that an exploration score for a user is a value from 0 to 1. In this example, a score of 0 may indicate the user is more conservative than adventurous and therefore unlikely to interact with content associated with less than a threshold measure of familiarity to the user. In the above example, a score of 1 may indicate the user is more adventurous than conservative and therefore likely to interact with content associated with less than the threshold measure of familiarity to the user. Content associated with less than a threshold measure of familiarity to a user may include content with which the user interacted less than a threshold number of times or less than a threshold percentage of times when presented to the user, content that became available within a threshold amount of time of a current time, or any other suitable types of content. For example, content associated with less than a threshold measure of familiarity to a user may include new items (e.g., new brands or new versions/varieties of items) that became available at a retailer location within a threshold amount of time of a current time. As an additional example, content associated with less than a threshold measure of familiarity to a user may include items or recipes with which the user has never interacted when presented with the items or recipes.

The scoring module 212 may predict an exploration score for a user based on data it retrieves from the data store 240, such as a set of user data for the user, item data, recipe data, or any other suitable types of data. For example, the scoring module 212 may predict an exploration score for a user based on a set of user data for the user including historical conversion, interaction, contextual, or location information associated with the user, information describing the user's preferences (e.g., shopping or dietary preferences), interests, or hobbies, demographic or household information associated with the user, etc. In the above example, the scoring module 212 also may predict the exploration score for the user based on a set of item data for each item the user previously ordered or purchased, a set of item data for each item with which the user previously interacted, a set of item data for each item previously presented to the user but with which the user did not interact, etc.

An exploration score for a user may be proportional to various values included among a set of user data for the user. For example, an exploration score for a user may be proportional to a ratio of a number of conversions by the user associated with one or more item categories to an average number of conversions by users of the online system 140 associated with the item category/categories (e.g., users in the same geographical region or users who purchased or ordered items from the same retailer location as the user). In this example, the exploration score also may be proportional to a ratio of a number of interactions by the user associated with one or more distinct items or recipes to an average number of interactions by users of the online system 140 associated with distinct items or recipes (e.g., users in the same geographical region as the user). In the above example, the exploration score also may be proportional to a ratio of a measure of uniqueness of a set of items included in one or more shopping lists, orders, or purchases associated with the user to an average measure of uniqueness of items included in shopping lists, orders, or purchases associated with users of the online system 140. In this example, the users may be in the same geographical region as the user or the users may have purchased or ordered items from the same retailer location as the user. As an additional example, an exploration score for a user may be proportional to an amount of time elapsed between a time that the user picked up an item at a retailer location and added the item to a shopping cart or a shopping basket, a number of aisles in one or more retailer locations visited by the user, or a number of different routes the user has taken at each retailer location the user visited.

An exploration score for a user predicted by the scoring module 212 also may be inversely proportional to various values included among a set of user data for the user. For example, an exploration score for a user may be inversely proportional to an amount of time elapsed between a time an item first became available at a retailer location and a time that the user added the item to a shopping list associated with the retailer location or ordered or purchased the item from the retailer location. As an additional example, an exploration score for a user may be inversely proportional to a number or a percentage of items the user ordered or purchased after sampling the items. As yet another example, suppose that a set of user data describes a set of conversions by a user with a set of items associated with types of social proof corresponding to a rating and reviews for each item. In this example, the exploration score for the user may be inversely proportional to a rating and a number of reviews for each item. In the above example, suppose that the set of user data also describes a set of interactions by the user with a set of recipes (e.g., saving or sharing the set of recipes, indicating they made the set of recipes, etc.) associated with the same types of social proof. In this example, the exploration score for the user also may be inversely proportional to a rating and a number of reviews for each recipe.

In some embodiments, an exploration score for a user is specific to one or more attributes associated with content that may be presented to the user. In such embodiments, the exploration score describes a likelihood of a set of interactions by the user with content associated with less than a threshold measure of familiarity to the user, in which the content is associated with the attribute(s). For example, an exploration score for a user that is specific to a single item category or brand may indicate a likelihood of a set of interactions by the user with content associated with less than a threshold measure of familiarity to the user, in which the content is also associated with the item category or brand. In embodiments in which an exploration score for a user is specific to one or more attributes associated with content that may be presented to the user, the attribute(s) may be described by one or more search queries received from a user client device 100 associated with the user. For example, suppose that a search query received from a user client device 100 associated with a user includes a vague description of items associated with a “cheese” item category, such as “Some kind of hard cheese,” or a specific description of items associated with the item category, such as “8 oz of Brand X extra sharp cheddar cheese.” In this example, the scoring module 212 may predict an exploration score for the user that is specific to the “cheese” item category. Furthermore, in embodiments in which an exploration score for a user is specific to one or more attributes associated with content that may be presented to the user, the exploration score may be inversely proportional to a number of the attribute(s). In the above example, the exploration score for the user may be higher if it is based on the vague description than if it is based on the specific description since the vague description includes two attributes (i.e., an item category and a threshold measure of firmness), while the specific description includes four attributes (i.e., a size, a brand, a variety, and an item category).

In some embodiments, the scoring module 212 predicts an exploration score for a user using an exploration prediction model, which is a machine-learning model trained to predict an exploration score for a user. To use the exploration prediction model, the scoring module 212 may access the model (e.g., from the data store 240) and apply the model to a set of inputs. The set of inputs may include one or more types of data retrieved by the scoring module 212 described above. For example, the scoring module 212 may access and apply the exploration prediction model to a set of inputs including a set of user data describing a set of previous interactions by a user with the online system 140, such as a set of interactions by the user with various items or recipes presented to the user by the online system 140. In this example, the set of inputs also may include a set of item data or recipe data for each item or recipe with which the user previously interacted, a set of item data or recipe data for each item or recipe previously presented to the user with which the user did not interact, etc. In embodiments in which the exploration score being predicted is specific to one or more attributes associated with content that may be presented to the user, the set of inputs may be specific to the attribute(s). In the above example, the set of inputs alternatively may include information describing a set of previous interactions by the user with items associated with a single item category and a set of item data for each item associated with the item category.

Once the scoring module 212 applies the exploration prediction model to a set of inputs, the scoring module 212 may receive an output from the model, which may include a value corresponding to an exploration score for a user. The scoring module 212 may then communicate the exploration score to the data collection module 200, which may store the exploration score in the data store 240 among a set of user data for the user. The exploration score may be stored in association with a time at which it was predicted or in association with any other suitable types of information. In some embodiments, the exploration prediction model is trained by the machine-learning training module 230, as described below.

In some embodiments, the ranking module 213 identifies a set of candidate content (e.g., a set of candidate items, recipes, images, videos, audio files, social media posts, advertisements, coupons, etc.) to recommend to a user. The ranking module 213 may do so based on an exploration score for the user and information describing a set of previous interactions by the user with the set of candidate content. The information describing the set of previous interactions by the user may describe a measure of familiarity of the set of candidate content to the user (e.g., a number of previous interactions by the user with the set of candidate content, a frequency of interactions by the user when presented with the set of candidate content, etc.). For example, if an exploration score for a user is at least a threshold score, the ranking module 213 may identify a set of items, recipes, or other types of content with which the user previously interacted less than a threshold number of times or with less than a threshold frequency as a set of candidate content to recommend to the user. Alternatively, in the above example, if the exploration score is less than the threshold score, the ranking module 213 may identify a different set of items, recipes, or other types of content with which the user previously interacted at least the threshold number of times or with at least the threshold frequency as the set of candidate content to recommend to the user. The ranking module 213 also may identify the set of candidate content to recommend to the user based on additional types of user data for the user or any other suitable types of information. For example, suppose that a set of user data includes historical location information indicating that a user recently visited Southeast Asia. In this example, if an exploration score for the user is at least a threshold score, the ranking module 213 may identify a set of content associated with Southeast Asia with which the user interacted less than a threshold number of times or with less than a threshold frequency as a set of candidate content to recommend to the user.

In some embodiments, a set of candidate content identified by the ranking module 213 is associated with one or more common attributes. For example, if an exploration score for a user is specific to an item category, a brand, or another attribute, and the score is at least a threshold score, the ranking module 213 may identify candidate items associated with the item category, brand, etc., in which the candidate items correspond to items with which the user has previously interacted less than a threshold number of times or with less than a threshold frequency. Alternatively, in the above example, if the exploration score is less than the threshold score, the candidate items identified by the ranking module 213 may be associated with the item category, brand, etc., in which the candidate items correspond to items with which the user has previously interacted at least the threshold number of times or with at least the threshold frequency.

In embodiments in which the ranking module 213 receives information describing a response to a prompt received from a user client device 100 associated with a user, as described below, the ranking module 213 may identify a set of candidate content to recommend to the user based on the response. For example, suppose that the interface module 211 generates a prompt for a user to select a country by interacting with an interactive globe. In this example, the ranking module 213 may receive information describing a country selected by the user and identify a set of candidate content associated with the country (e.g., a set of items, recipes, images, videos, social media posts, music, or podcasts associated with the country, advertisements to visit the country, coupons for items associated with the country, etc.) to recommend to the user.

The ranking module 213 also may rank content (e.g., a set of candidate content) that may be recommended to a user. The ranking module 213 may do so based on an exploration score for the user and information describing a set of previous interactions by the user with the content, which may correspond to information describing a measure of familiarity of the content to the user, as described above. To rank the content, the ranking module 213 may first determine whether the exploration score for the user is at least a threshold score. Responsive to determining that the exploration score is at least the threshold score, the ranking module 213 may rank the content, such that a rank of a content item (e.g., an item, a recipe, an image, a video, an audio file, a social media post, an advertisement, a coupon, etc.) is inversely proportional to a measure of familiarity of the content item to the user. Similarly, responsive to determining that the exploration score is less than the threshold score, the ranking module 213 may rank the content, such that a rank of a content item is proportional to a measure of familiarity of the content item to the user.

The following examples illustrate how the ranking module 213 may rank content that may be recommended to a user. Suppose that the ranking module 213 has determined that an exploration score for a user is at least a threshold score and has identified a set of candidate content associated with less than a threshold measure of familiarity to the user. In this example, the ranking module 213 may rank the set of candidate content based on information describing a set of previous interactions by the user with the set of candidate content, such that a candidate content item with which the user interacted the least is ranked the highest and a candidate content item with which the user interacted the most is ranked the lowest. As an additional example, suppose that the ranking module 213 has determined that an exploration score for a user is less than a threshold score and has identified a set of candidate content associated with at least a threshold measure of familiarity to the user. In this example, the ranking module 213 may rank the set of candidate content based on information describing a set of previous interactions by the user with the set of candidate content, such that a candidate content item with which the user interacted the most is ranked the highest and a candidate content item with which the user interacted the least is ranked the lowest.

The selection module 214 may select a set of content (e.g., from a set of candidate content) to recommend to a user. The selection module 214 may do so based on an exploration score for the user, information describing a set of previous interactions by the user with the set of content (e.g., information describing a measure of familiarity of the set of content to the user), or a ranking of the set of content. To select the set of content, the selection module 214 may first determine whether the exploration score for the user is at least a threshold score. Responsive to determining that the exploration score is at least the threshold score, the selection module 214 may select a set of content with which the user interacted less than a threshold number of times or with less than a threshold frequency to recommend to the user. Similarly, responsive to determining that the exploration score is less than the threshold score, the selection module 214 may select a set of content with which the user interacted at least a threshold number of times or with at least a threshold frequency to recommend to the user. In embodiments in which the ranking module 213 ranks content (e.g., candidate content items), the selection module 214 may select a set of content with a rank that exceeds some threshold (e.g., the top n ranked candidate content items).

In various embodiments, the selection module 214 also may select a set of content to recommend to a user based on additional types of information, such as additional types of user data for the user, item data for various items, or any other suitable types of information. For example, suppose that a set of user data includes information describing routes a user has taken at a retailer location visited by the user. In this example, responsive to determining that an exploration score for the user is at least a threshold score, the selection module 214 may select items available at the retailer location to recommend to the user based on item data for the items describing a location associated with each item within the retailer location, such that the items are associated with locations along a route the user has taken less than a threshold number of times. Alternatively, in the above example, the route may include aisles or departments in which the user has spent less than a threshold amount of time.

In some embodiments, an exploration score for a user is used by the selection module 214 for purposes other than selecting a set of content to recommend to the user, such as selecting replacement content for the user, or for any other suitable purpose. For example, suppose that an item a user ordered is not available at a retailer location from which the item is to be collected. In this example, an exploration score for the user may be included among a set of inputs to which a machine-learning model is applied, in which the machine-learning model is trained to identify a replacement for an item that is not available. In the above example, a measure of similarity between the item that is not available and a replacement identified in an output of the machine-learning model, which may be described by a number of attributes the item and the replacement share, may be inversely proportional to the exploration score for the user.

In some embodiments, the interface module 211 generates a prompt that it sends to a user client device 100 associated with a user, causing the user client device 100 to display the prompt. Once the prompt is displayed to the user, the interface module 211 may receive a response to the prompt, which it may communicate to the ranking module 213, as described above. For example, suppose that the interface module 211 generates a prompt that includes an interactive image of a globe and the following text: “Spin the globe and pick a country.” In this example, if a user to whom the prompt is presented follows the instructions (e.g., by swiping a screen of a user client device 100 associated with the user and touching the screen again to stop the globe and select a country), the interface module 211 may receive information describing a country selected by the user and communicate it to the ranking module 213.

In various embodiments, the interface module 211 generates and transmits a user interface that includes content recommended to a user, which may or may not be an ordering interface. The interface module 211 may do so in response to receiving a request from a user client device 100 associated with a user to access the user interface. The user interface may include a set of content selected by the selection module 214 for recommendation to the user. For example, the user interface generated by the interface module 211 may include a set of content corresponding to a set of items, recipes, images, videos, audio files, social media posts, advertisements, coupons, etc. recommended to a user to whom the user interface is to be presented. In this example, once the interface module 211 generates the user interface, it may send the user interface to a user client device 100 associated with the user, causing the user client device 100 to display the user interface. Once the user interface is displayed to the user, the user may interact with the user interface. Continuing with the above example, the user may interact with the set of content by adding an item included among the set of content to a shopping list, saving a recipe included among the set of content, watching a video included among the set of content, listening to an audio file included among the set of content, sharing the set of content with other users of the online system 140, etc. The user interface may include information indicating why the set of content is being recommended to the user. For example, suppose that recipes selected by the selection module 214 were identified by the ranking module 213 based on a set of user data indicating that a user recently visited Southeast Asia and an exploration score for the user that is at least a threshold score. In this example, the user interface may include the selected recipes and a label for the recipes (e.g., “Feeling adventurous today? Explore Southeast Asia!”).

The interface module 211 also may generate a user interface based on various types of information. In some embodiments, the interface module 211 generates the user interface based on an exploration score for a user. For example, if the selection module 214 selects items responsive to determining that an exploration score for a user is at least a threshold score, the user interface generated by the interface module 211 may include a mystery bag of items, such that the selected items are included in the mystery bag of items and information describing the items is not revealed in the user interface. In this example, to encourage the user to interact with the items, the items may be associated with an incentive, such as a discount. In various embodiments, the interface module 211 generates the user interface based on a route associated with a set of content selected by the selection module 214. For example, suppose that responsive to determining that an exploration score for a user is at least a threshold score, the selection module 214 has selected items available at a retailer location for recommendation to a user based on item data for the items describing a location associated with each item within the retailer location, such that the items are associated with locations along a route the user has taken less than a threshold number of times. In this example, the user interface generated by the interface module 211 may include the route within the retailer location (e.g., a map that indicates where the items are located along the route) and indicate that the purpose of the route is for the user to explore items associated with less than a threshold measure of familiarity to the user.

The interface module 211 also may determine an arrangement of a set of content included in a user interface. The interface module 211 may determine the arrangement of the set of content based on an exploration score for a user. For example, the interface module 211 may determine an arrangement of content presentation units (e.g., carousels) within the user interface based on an exploration score for a user, such that a content presentation unit including a set of content selected by the selection module 214 for recommendation to the user may be located in a prominent position within the user interface if the exploration score is at least a threshold score. Alternatively, in the above example, the content presentation unit may be located in a less prominent position within the user interface if the exploration score is less than the threshold score. In embodiments in which the set of content included in the user interface is ranked by the ranking module 213, the interface module 211 may determine an arrangement of the set of content based on the ranking and generate the user interface based on the arrangement. For example, the interface module 211 may determine an arrangement of items selected for recommendation to a user based on a ranking of the items and generate the user interface based on the determination, such that a highest ranked item is located in a most prominent position of the user interface, a second-highest ranked item is located in a second-most prominent position of the user interface, etc.

The interface module 211 also may determine an arrangement of a set of content included in a user interface based on a request received from a user client device 100 associated with a user to access the user interface or based on any other suitable types of information. For example, suppose that the interface module 211 receives a request from a user client device 100 associated with a user to access a user interface including a set of search results. In this example, the interface module 211 may determine an arrangement of content presentation units within the user interface based on the request, such that a content presentation unit including content (e.g., best-selling items) that is related to a search query received from the user client device 100 may be located in a most prominent position of the user interface. In this example, a content presentation unit including a set of content recommended to the user that is less related to the search query may be located in a less prominent position of the user interface (e.g., below other content that is also related to the search query).

The order management module 220 manages orders for items from users. The order management module 220 receives orders from user client devices 100 and assigns the orders to pickers for service based on picker data. For example, the order management module 220 assigns an order to a picker based on the picker's location and the retailer location from which the ordered items are to be collected. The order management module 220 may also assign an order to a picker based on how many items are in the order, a vehicle operated by the picker, the delivery location, the picker's preferences for how far to travel to deliver an order, the picker's ratings by users, or how often the picker agrees to service an order.

In some embodiments, the order management module 220 determines when to assign an order to a picker based on a delivery timeframe requested by the user who placed the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online system 140. The online system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model is used by the machine-learning model to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, recipe data, conversion data, or other types of data stored in the data store 240. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

In embodiments in which the scoring module 212 accesses and applies the exploration prediction model to predict an exploration score for a user, the machine-learning training module 230 may train the exploration prediction model. The machine-learning training module 230 may train the exploration prediction model via supervised learning or using any other suitable technique or combination of techniques based on data stored in the data store 240 or any other suitable types of data. For example, the machine-learning training module 230 may train the exploration prediction model based on user data stored in the data store 240. In the above example, the machine-learning training module 230 also may train the exploration prediction model based on item data, recipe data, or data associated with other types of content (e.g., images, videos, audio files, coupons, advertisements, social media posts, etc.) stored in the data store 240.

To illustrate an example of how the machine-learning training module 230 may train the exploration prediction model, suppose that the machine-learning training module 230 receives a set of training examples including various attributes of users of the online system 140. In this example, the set of training examples may describe historical interaction, conversion, contextual, or location information associated with each user. In the above example, the set of training examples also may describe each user's shopping or dietary preferences, demographic or household information associated with each user, information describing each user's interests or hobbies, information derived from other user data for each user, etc. In this example, the set of training examples also may include attributes of the items (e.g., item categories, brands, etc.), recipes (e.g., cuisines, ingredients, etc.), or other types of content with which each user interacted or attributes of items the user previously ordered or purchased. In the above example, the machine-learning training module 230 also may receive labels which represent expected outputs of the exploration prediction model, in which a label corresponds to an exploration score for a corresponding user. Continuing with this example, the machine-learning training module 230 may then train the exploration prediction model based on the attributes, as well as the labels by comparing its output from input data of each training example to the label for the training example.

In embodiments in which the machine-learning training module 230 trains the exploration prediction model based on a label corresponding to an exploration score for a user, the machine-learning training module 230 may determine the label. The machine-learning training module 230 may do so using a set of heuristic techniques for labeling each user or using any other suitable technique or combination of techniques. For example, the machine-learning training module 230 may assign labels corresponding to exploration scores for users using a trial-and-error method (e.g., by randomly labeling the users). In this example, once each user is presented with a user interface including a set of content recommended to the user that was selected based on an exploration score assigned to the user, the machine-learning training module 230 may receive information describing a set of interactions by the user with the set of content and adjust the exploration score for the user based on the set of interactions. In the above example, the exploration score may be adjusted by increasing it if the recommended content with which the user interacts the most or most frequently is content with which the user previously interacted less than a threshold number of times or with less than a threshold frequency. Similarly, in the above example, the exploration score may be adjusted by decreasing it if the recommended content with which the user interacts the most or most frequently is content with which the user previously interacted more than a threshold number of times or with more than a threshold frequency. In this example, this process may be repeated to refine the exploration score for each user and the machine-learning training module 230 may determine the label corresponding to the exploration score for each user based on information describing one or more sets of interactions of a corresponding user with one or more sets of content recommended to the user.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In situations in which the training example includes a label, the loss function is also based on the label for the training example. Some example loss functions include the mean square error function, the mean absolute error, the hinge loss function, and the cross-entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, recipe data, conversion data, picker data, etc. for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

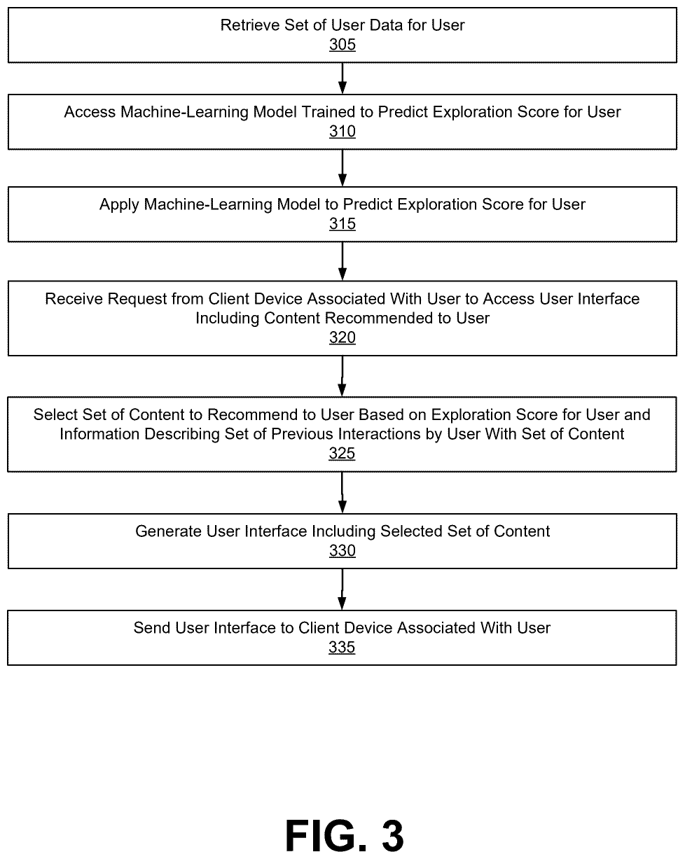

FIG. 3 is a flowchart for a method for recommending content based on a predicted exploration score for a user of an online system, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140), such as an online concierge system. Additionally, each of these steps may be performed automatically by the online system 140 without human intervention.

The online system 140 retrieves 305 (e.g., using the scoring module 212) a set of user data for a user. The set of user data may include historical information associated with the user, such as historical interaction information describing one or more interactions by the user with the online system 140. The set of user data also may include additional types of information associated with the user. Examples of such types of information include: historical conversion, contextual, or location information associated with the user, information describing the user's shopping or dietary preferences, demographic or household information associated with the user, information describing the user's interests or hobbies, information derived from other user data for the user, or any other suitable types of information. In some embodiments, the online system 140 also retrieves (step 305) additional types of data (e.g., from the data store 240). Examples of such types of data include: item data, recipe data, or data for any other types of content.

The online system 140 then predicts (e.g., using the scoring module 212) an exploration score for the user describing a likelihood of a set of interactions by the user with content associated with less than a threshold measure of familiarity to the user. The exploration score may correspond to a value, such as a number (e.g., from 0 to 1) or a percentage. Content associated with less than the threshold measure of familiarity to the user may include content with which the user interacted less than a threshold number of times or less than a threshold percentage of times when presented to the user, content that became available within a threshold amount of time of a current time, or any other suitable types of content. The online system 140 may predict the exploration score for the user based on the data it retrieves 305, such as the set of user data for the user, item data, recipe data, etc. The exploration score for the user may be proportional to various values included among the set of user data for the user (e.g., a number of aisles in one or more retailer locations visited by the user, a number of different routes the user has taken at each retailer location the user visited, etc.). The exploration score for the user also may be inversely proportional to various values included among the set of user data for the user (e.g., a number or a percentage of items the user ordered or purchased after sampling the items, a rating or a number of reviews for a set of items the user ordered or purchased, etc.).

In some embodiments, the exploration score is specific to one or more attributes associated with content that may be presented to the user. In such embodiments, the exploration score describes a likelihood of a set of interactions by the user with content associated with less than a threshold measure of familiarity to the user, in which the content is associated with the attribute(s). Furthermore, the attribute(s) may be described by one or more search queries received from a user client device 100 associated with the user. Additionally, the exploration score may be inversely proportional to a number of the attribute(s).

In some embodiments, the online system 140 predicts the exploration score for the user using an exploration prediction model, which is a machine-learning model trained to predict an exploration score for a user. To use the exploration prediction model, the online system 140 may access 310 (e.g., using the scoring module 212) the model (e.g., from the data store 240) and apply 315 (e.g., using the scoring module 212) the model to a set of inputs. The set of inputs may include one or more types of data retrieved 305 by the online system 140 described above. In embodiments in which the exploration score being predicted is specific to one or more attributes associated with content that may be presented to the user, the set of inputs may be specific to the attribute(s). Once the online system 140 applies 315 the exploration prediction model to the set of inputs, the online system 140 may receive (e.g., via the scoring module 212) an output from the model, which may include a value corresponding to the exploration score for the user. The online system 140 may then store (e.g., using the data collection module 200) the exploration score (e.g., in the data store 240 among a set of user data for the user). The exploration score may be stored in association with a time at which it was predicted or any other suitable types of information. In some embodiments, the exploration prediction model is trained by the online system 140 (e.g., using the machine-learning training module 230).

The online system 140 then receives 320 (e.g., via the interface module 211) a request from a user client device 100 associated with the user to access a user interface including content recommended to the user. The user interface may correspond to the ordering interface, or it may include a set of search results or any other suitable types of content. The content recommended to the user may be included in one or more content presentation units (e.g., carousels) within the user interface.

In some embodiments, the online system 140 identifies (e.g., using the ranking module 213) a set of candidate content (e.g., a set of candidate items, recipes, images, videos, audio files, social media posts, advertisements, coupons, etc.) to recommend to the user based on the exploration score for the user and information describing a set of previous interactions by the user with the set of candidate content. The information describing the set of previous interactions by the user may describe a measure of familiarity of the set of candidate content to the user (e.g., a number of previous interactions by the user with the set of candidate content, a frequency of interactions by the user when presented with the set of candidate content, etc.). The online system 140 also may identify the set of candidate content to recommend to the user based on additional types of user data for the user (e.g., historical location information associated with the user) or any other suitable types of information. In some embodiments, the set of candidate content identified by the online system 140 is associated with one or more common attributes (e.g., if the exploration score is specific to the attribute(s)).

In some embodiments, the online system 140 generates (e.g., using the interface module 211) a prompt that it sends to the user client device 100 associated with the user, causing the user client device 100 to display the prompt. Once the prompt is displayed to the user, the online system 140 may receive (e.g., via the interface module 211) a response to the prompt. In embodiments in which the online system 140 receives a response to the prompt, the online system 140 may identify the set of candidate content based on the response.

The online system 140 also may rank (e.g., using the ranking module 213) content (e.g., the set of candidate content) that may be recommended to the user. The online system 140 may do so based on the exploration score for the user and information describing a set of previous interactions by the user with the content, which may correspond to information describing the measure of familiarity of the content to the user, as described above. To rank the content, the online system 140 may first determine (e.g., using the ranking module 213) whether the exploration score for the user is at least a threshold score. Responsive to determining that the exploration score is at least the threshold score, the online system 140 may rank the content, such that a rank of a content item (e.g., an item, a recipe, an image, a video, an audio file, a social media post, an advertisement, a coupon, etc.) is inversely proportional to a measure of familiarity of the content item to the user. Similarly, responsive to determining that the exploration score is less than the threshold score, the online system 140 may rank the content, such that a rank of a content item is proportional to a measure of familiarity of the content item to the user.

The online system 140 may select 325 (e.g., using the selection module 214) a set of content (e.g., from the set of candidate content) to recommend to the user. The online system 140 may do so based on the exploration score for the user, information describing a set of previous interactions by the user with the set of content (e.g., information describing a measure of familiarity of the set of content to the user), or a ranking of the set of content. To select 325 the set of content, the online system 140 may first determine (e.g., using the selection module 214) whether the exploration score for the user is at least a threshold score. Responsive to determining that the exploration score is at least the threshold score, the online system 140 may select 325 a set of content with which the user interacted less than a threshold number of times or with less than a threshold frequency to recommend to the user. Similarly, responsive to determining that the exploration score is less than the threshold score, the online system 140 may select 325 a set of content with which the user interacted at least a threshold number of times or with at least a threshold frequency to recommend to the user. In embodiments in which the online system 140 ranks content (e.g., candidate content items), the online system 140 may select 325 a set of content with a rank that exceeds some threshold (e.g., the top n ranked candidate content items). In some embodiments, the online system 140 also may select 325 the set of content based on additional types of information, such as additional types of user data for the user, item data for various items, or any other suitable types of information. In some embodiments, the exploration score for the user is used by the online system 140 for purposes other than selecting 325 the set of content to recommend to the user, such as selecting (e.g., using the selection module 214) replacement content for the user, or for any other suitable purpose.

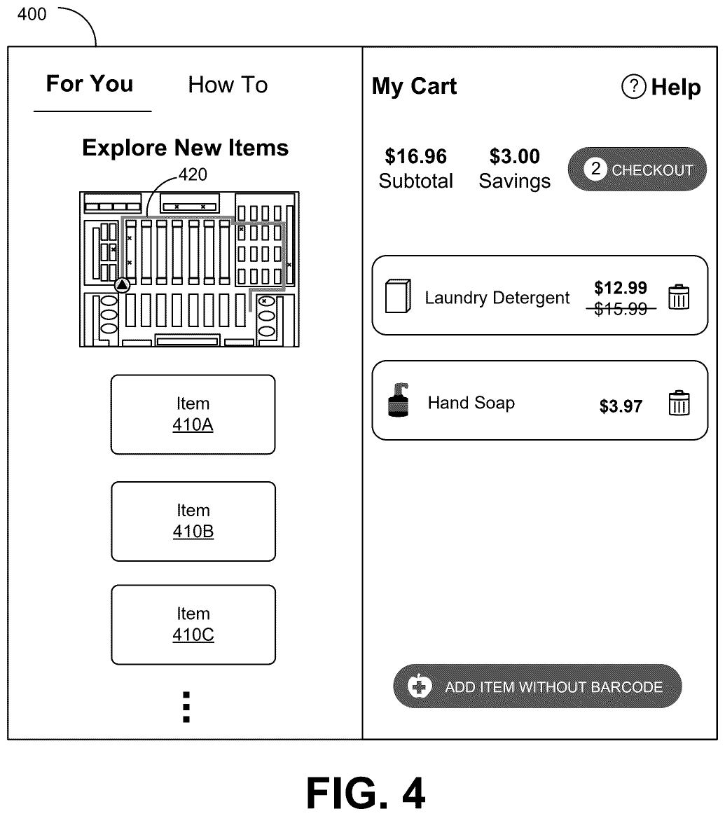

The online system 140 then generates 330 (e.g., using the interface module 211) the user interface. The user interface may include the set of content selected 325 by the online system 140 for recommendation to the user. The user interface may include information indicating why the set of content is being recommended to the user. The online system 140 also may generate 330 the user interface based on various types of information. In some embodiments, the online system 140 generates 330 the user interface based on the exploration score for the user (e.g., to include a mystery bag of items if the exploration score is at least a threshold score). In various embodiments, the online system 140 generates 330 the user interface based on a route within a retailer location associated with the selected set of content. FIGS. 4-7B illustrate examples of a user interface including a set of content recommended to a user of an online system, in accordance with one or more embodiments. Referring first to FIG. 4, suppose that responsive to determining that the exploration score for the user is at least a threshold score, the online system 140 has selected (step 325) items 410A-C available at a retailer location for recommendation to the user based on item data for the items 410A-C describing a location associated with each item 410A-C within the retailer location, such that the items 410A-C are located along a route 420 the user has taken less than a threshold number of times. In this example, the user interface 400 generated 330 by the online system 140 may include the route 420 within the retailer location (e.g., shown on a map that indicates where the items 410A-C are located along the route 420) and indicate that the purpose of the route 420 is for the user to explore items 410 associated with less than a threshold measure of familiarity to the user.

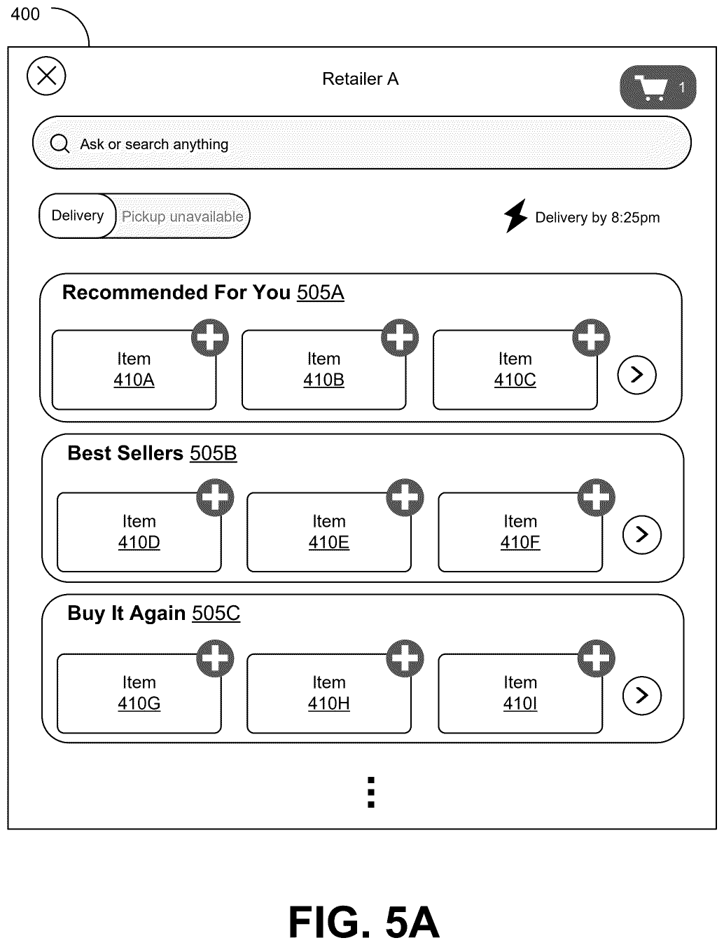

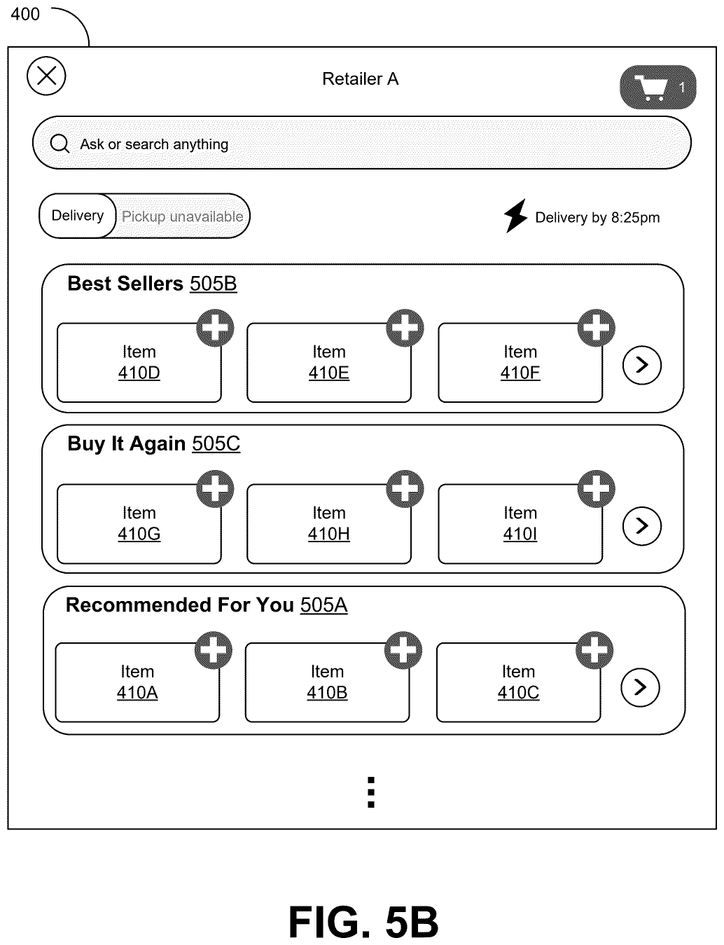

The online system 140 also may determine (e.g., using the interface module 211) an arrangement of the selected set of content included in the user interface 400. The online system 140 may determine the arrangement of the selected set of content based on the exploration score for the user. For example, as shown in FIG. 5A, the online system 140 may determine the arrangement of content presentation units (e.g., carousels) 505 within the user interface 400 based on the exploration score for the user, such that a content presentation unit 505A including a selected set of items 410A-C recommended to the user may be located in a most prominent position within the user interface 400 if the exploration score is at least a threshold score. In this example, the position of the content presentation unit 505A may be higher than the position of a content presentation unit 505B for best-selling items 410D-F and the position of a content presentation unit 505C for items 410G-I the user previously ordered. Alternatively, as shown in the example of FIG. 5B, the content presentation unit 505A including the selected set of items 410A-C recommended to the user may be located in a less prominent position within the user interface 400 if the exploration score is less than the threshold score. In embodiments in which the selected set of content is ranked by the online system 140, the online system 140 may determine the arrangement of the selected set of content based on the ranking and generate 330 the user interface 400 based on the arrangement.

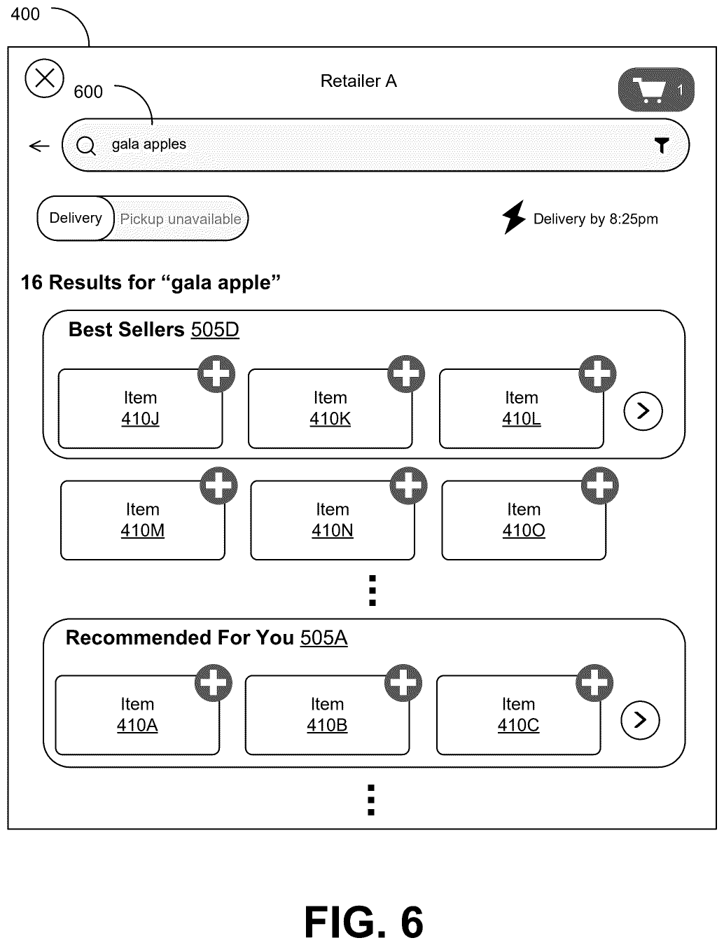

The online system 140 also may determine the arrangement of the selected set of content included in the user interface 400 based on the request received 320 from the user client device 100 associated with the user to access the user interface 400 or based on any other suitable types of information. For example, as shown in FIG. 6, suppose that the request received 320 by the online system 140 corresponds to a request to access a set of search results matching a search query 600 for “gala apples.” In this example, the online system 140 may determine the arrangement of content presentation units 505 within the user interface 400 based on the request, such that a content presentation unit 505D including best-selling items 410J-L that are related to the search query 600 may be located in a most prominent position of the user interface 400. In this example, a content presentation unit 505A including a selected set of items 410A-C recommended to the user that is less related to the search query 600 may be located in a less prominent position of the user interface 400 (e.g., below other items 410J-O that are also related to the search query 600).

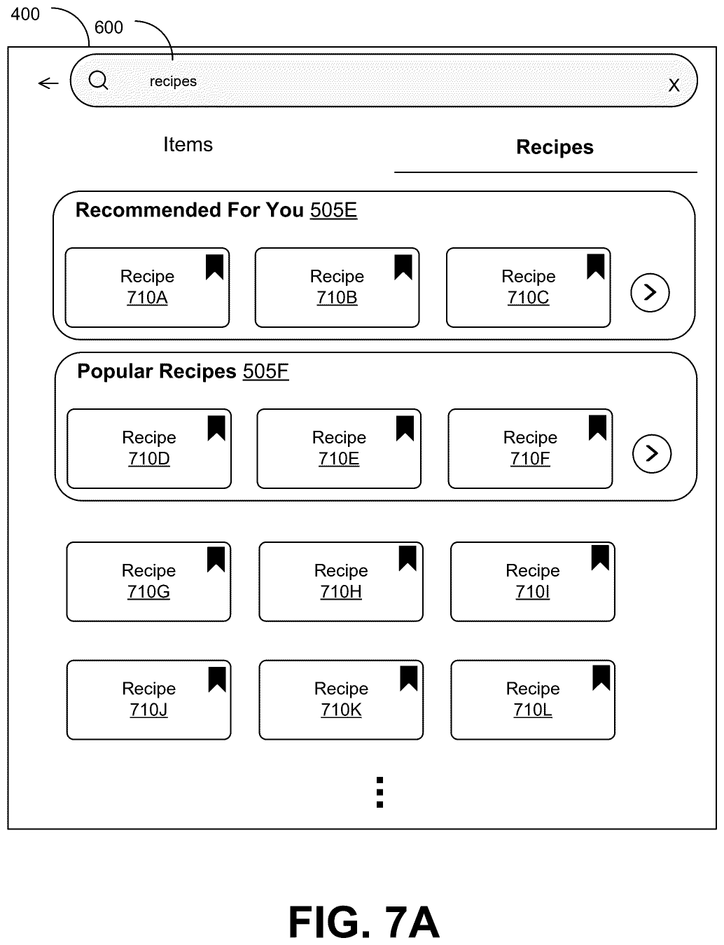

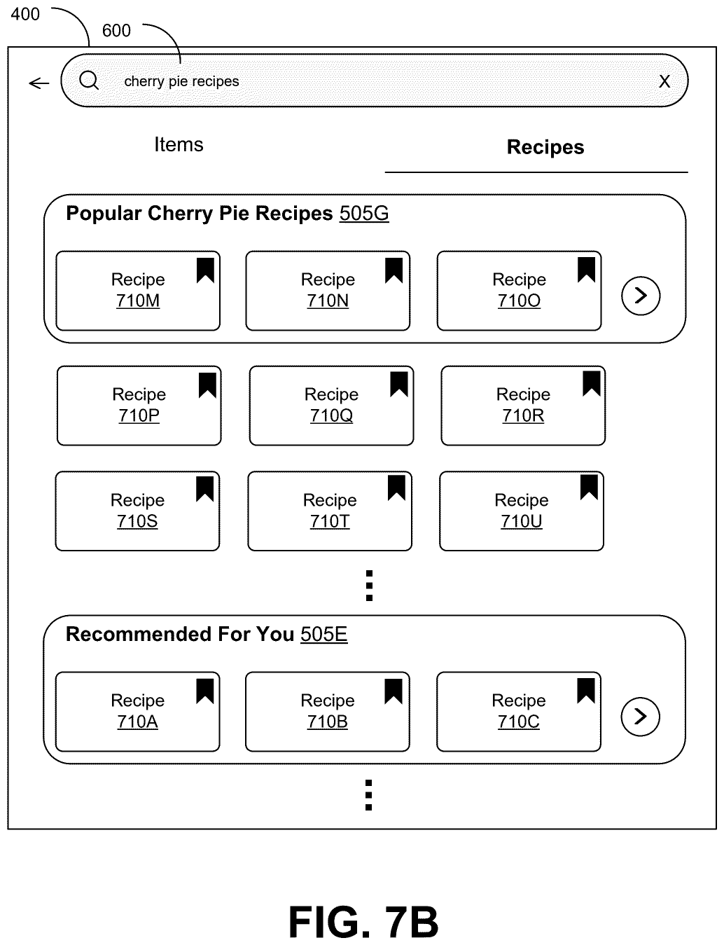

The following illustrates additional examples of how the online system 140 may determine the arrangement of the selected set of content included in the user interface 400 based on the request received 320 from the user client device 100 associated with the user to access the user interface 400. As shown in FIG. 7A, suppose that the request corresponds to a request to access a set of search results matching a search query 600 for “recipes.” In this example, the online system 140 may determine the arrangement of content presentation units 505 within the user interface 400 based on the request, such that a content presentation unit 505E including a selected set of recipes 710A-C recommended to the user may be located in a most prominent position of the user interface 400, while a content presentation unit 505F including popular recipes 710D-F may be located in a less prominent position of the user interface 400. Alternatively, as shown in FIG. 7B, suppose that the request received 320 by the online system 140 corresponds to a request to access a set of search results matching a search query 600 for “cherry pie recipes.” In this example, the online system 140 may determine the arrangement of the content presentation units 505 within the user interface 400 based on the request, such that the content presentation unit 505E including the selected set of recipes 710A-C recommended to the user may be located in an even less prominent position of the user interface 400 below a content presentation unit 505G including popular cherry pie recipes 710M-O and other recipes 710P-U that are more related to the search query 600.

Referring back to FIG. 3, once the online system 140 generates 330 the user interface 400, it may send 335 (e.g., using the interface module 211) the user interface 400 to the user client device 100 associated with the user, causing the user client device 100 to display the user interface 400. Once the user interface 400 is displayed to the user, the user may interact with the user interface 400. For example, suppose that the set of content included in the user interface 400 includes a set of items 410, recipes 710, images, videos, audio files, social media posts, advertisements, or coupons recommended to the user. In this example, the user may interact with the set of content by adding an item 410 included among the set of content to a shopping list, saving a recipe 710 included among the set of content, watching a video included among the set of content, listening to an audio file included among the set of content, sharing the set of content with other users of the online system 140, etc.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
retrieving a set of user data for a user of an online system, wherein the set of user data comprises information describing one or more interactions by the user with the online system;
accessing a machine-learning model trained to predict an exploration score for the user, wherein the exploration score describes a likelihood of a set of interactions by the user with content associated with less than a threshold measure of familiarity to the user, and the machine-learning model is trained by:
receiving user data for a plurality of users of the online system,
receiving, for each user of the plurality of users, a label describing the exploration score for a corresponding user, and
training the machine-learning model based at least in part on the user data and the label for each user of the plurality of users;
applying the machine-learning model to predict the exploration score for the user based at least in part on the set of user data for the user;
receiving a request from a client device associated with the user to access a user interface comprising content recommended to the user;
selecting a set of content to recommend to the user based at least in part on the exploration score for the user and information describing a set of previous interactions by the user with the set of content;
generating the user interface comprising the selected set of content; and
sending the user interface to the client device associated with the user, wherein sending the user interface causes the client device to display the user interface.

2. The method of claim 1, wherein the likelihood of the set of interactions by the user with content associated with less than the threshold measure of familiarity to the user comprises the likelihood of the set of interactions by the user with one or more items associated with an item category having less than the threshold measure of familiarity to the user.

3. The method of claim 1, wherein retrieving the set of user data for the user of the online system comprises retrieving one or more of: a ratio of a number of conversions by the user associated with one or more item categories to an average number of conversions by a plurality of users associated with the one or more item categories, a ratio of a number of interactions by the user associated with one or more distinct items to an average number of interactions by a plurality of users associated with the one or more distinct items, a ratio of a number of interactions by the user associated with one or more distinct recipes to an average number of interactions by a plurality of users associated with the one or more distinct recipes, a ratio of a measure of uniqueness of a set of items included in a shopping list associated with the user to an average measure of uniqueness of items included in shopping lists associated with a plurality of users, information describing a set of aisles in a retailer location visited by the user, information describing a set of interactions by the user with a set of items associated with a type of social proof, information describing a set of interactions by the user with a set of recipes associated with a type of social proof, an amount of time elapsed between a time a new item became available at a retailer location and a time of a conversion by the user associated with the new item, or a number of conversions by the user associated with a set of items the user sampled.

4. The method of claim 1, further comprising:
generating, for each user of the plurality of users, the label describing the exploration score for the corresponding user based at least in part on a set of heuristic techniques for labeling each user of the plurality of users.

5. The method of claim 1, wherein receiving, for each user of the plurality of users, the label describing the exploration score for the corresponding user comprises receiving the label from a client device associated with the corresponding user.

6. The method of claim 1, wherein receiving, for each user of the plurality of users, the label describing the exploration score for the corresponding user comprises:
receiving information describing an additional set of previous interactions by the corresponding user with a set of content recommended to the corresponding user; and
generating the label describing the exploration score for the corresponding user based at least in part on the additional set of previous interactions.

7. The method of claim 1, wherein selecting the set of content to recommend to the user based at least in part on the exploration score for the user and information describing the set of previous interactions by the user with the set of content comprises:
identifying a set of candidate content to recommend to the user based at least in part on the exploration score for the user and information describing the set of previous interactions by the user with one or more of: a plurality of items or a plurality of recipes;
ranking the set of candidate content to recommend to the user based at least in part on the exploration score for the user and information describing the set of previous interactions by the user; and
selecting the set of content to recommend to the user based at least in part on the ranking.

8. The method of claim 7, further comprising:
determining that the exploration score for the user is at least a threshold score; and
responsive to determining that the exploration score for the user is at least the threshold score, ranking the set of candidate content to recommend to the user based at least in part on information describing the set of previous interactions by the user with the candidate content, wherein a rank of a candidate content item is inversely proportional to a measure of familiarity of a corresponding candidate content item to the user.

9. The method of claim 7, further comprising:
determining that the exploration score for the user is less than a threshold score; and
responsive to determining that the exploration score for the user is less than the threshold score, ranking the set of candidate content to recommend to the user based at least in part on information describing the set of previous interactions by the user with the candidate content, wherein a rank of a candidate content item is proportional to a measure of familiarity of a corresponding candidate content item to the user.

10. The method of claim 7, wherein generating the user interface comprising the selected set of content comprises:
determining an arrangement of the selected set of content based at least in part on the ranking; and
generating the user interface based at least in part on the arrangement of the selected set of content.

11. A computer program product comprising a non-transitory computer-readable storage medium having instructions encoded thereon that, when executed by a processor, cause the processor to perform steps comprising:
retrieving a set of user data for a user of an online system, wherein the set of user data comprises information describing one or more interactions by the user with the online system;
accessing a machine-learning model trained to predict an exploration score for the user, wherein the exploration score describes a likelihood of a set of interactions by the user with content associated with less than a threshold measure of familiarity to the user, and the machine-learning model is trained by:
receiving user data for a plurality of users of the online system,
receiving, for each user of the plurality of users, a label describing the exploration score for a corresponding user, and
training the machine-learning model based at least in part on the user data and the label for each user of the plurality of users;
applying the machine-learning model to predict the exploration score for the user based at least in part on the set of user data for the user;
receiving a request from a client device associated with the user to access a user interface comprising content recommended to the user;
selecting a set of content to recommend to the user based at least in part on the exploration score for the user and information describing a set of previous interactions by the user with the set of content;
generating the user interface comprising the selected set of content; and
sending the user interface to the client device associated with the user, wherein sending the user interface causes the client device to display the user interface.

12. The computer program product of claim 11, wherein the likelihood of the set of interactions by the user with content associated with less than the threshold measure of familiarity to the user comprises the likelihood of the set of interactions by the user with one or more items associated with an item category having less than the threshold measure of familiarity to the user.

13. The computer program product of claim 11, wherein retrieving the set of user data for the user of the online system comprises retrieving one or more of: a ratio of a number of conversions by the user associated with one or more item categories to an average number of conversions by a plurality of users associated with the one or more item categories, a ratio of a number of interactions by the user associated with one or more distinct items to an average number of interactions by a plurality of users associated with the one or more distinct items, a ratio of a number of interactions by the user associated with one or more distinct recipes to an average number of interactions by a plurality of users associated with the one or more distinct recipes, a ratio of a measure of uniqueness of a set of items included in a shopping list associated with the user to an average measure of uniqueness of items included in shopping lists associated with a plurality of users, information describing a set of aisles in a retailer location visited by the user, information describing a set of interactions by the user with a set of items associated with a type of social proof, information describing a set of interactions by the user with a set of recipes associated with a type of social proof, an amount of time elapsed between a time a new item became available at a retailer location and a time of a conversion by the user associated with the new item, or a number of conversions by the user associated with a set of items the user sampled.

14. The computer program product of claim 11, wherein the computer-readable storage medium further has instructions encoded thereon that, when executed by the processor, cause the processor to perform steps comprising:
generating, for each user of the plurality of users, the label describing the exploration score for the corresponding user based at least in part on a set of heuristic techniques for labeling each user of the plurality of users.

15. The computer program product of claim 11, wherein receiving, for each user of the plurality of users, the label describing the exploration score for the corresponding user comprises receiving the label from a client device associated with the corresponding user.

16. The computer program product of claim 11, wherein receiving, for each user of the plurality of users, the label describing the exploration score for the corresponding user comprises:
receiving information describing an additional set of previous interactions by the corresponding user with a set of content recommended to the corresponding user; and
generating the label describing the exploration score for the corresponding user based at least in part on the additional set of previous interactions.

17. The computer program product of claim 11, wherein selecting the set of content to recommend to the user based at least in part on the exploration score for the user and information describing the set of previous interactions by the user with the set of content comprises:
identifying a set of candidate content to recommend to the user based at least in part on the exploration score for the user and information describing the set of previous interactions by the user with one or more of: a plurality of items or a plurality of recipes;
ranking the set of candidate content to recommend to the user based at least in part on the exploration score for the user and information describing the set of previous interactions by the user; and
selecting the set of content to recommend to the user based at least in part on the ranking.

18. The computer program product of claim 17, wherein the computer-readable storage medium further has instructions encoded thereon that, when executed by the processor, cause the processor to perform steps comprising:
determining that the exploration score for the user is at least a threshold score; and
responsive to determining that the exploration score for the user is at least the threshold score, ranking the set of candidate content to recommend to the user based at least in part on information describing the set of previous interactions by the user with the candidate content, wherein a rank of a candidate content item is inversely proportional to a measure of familiarity of a corresponding candidate content item to the user.

19. The computer program product of claim 17, wherein the computer-readable storage medium further has instructions encoded thereon that, when executed by the processor, cause the processor to perform steps comprising:
determining that the exploration score for the user is less than a threshold score; and
responsive to determining that the exploration score for the user is less than the threshold score, ranking the set of candidate content to recommend to the user based at least in part on information describing the set of previous interactions by the user with the candidate content, wherein a rank of a candidate content item is proportional to a measure of familiarity of a corresponding candidate content item to the user.

20. A computer system comprising:
a processor; and
a non-transitory computer-readable storage medium storing instructions that, when executed by the processor, perform actions comprising:
retrieving a set of user data for a user of an online system, wherein the set of user data comprises information describing one or more interactions by the user with the online system;
accessing a machine-learning model trained to predict an exploration score for the user, wherein the exploration score describes a likelihood of a set of interactions by the user with content associated with less than a threshold measure of familiarity to the user, and the machine-learning model is trained by:
receiving user data for a plurality of users of the online system,
receiving, for each user of the plurality of users, a label describing the exploration score for a corresponding user, and
training the machine-learning model based at least in part on the user data and the label for each user of the plurality of users;
applying the machine-learning model to predict the exploration score for the user based at least in part on the set of user data for the user;
receiving a request from a client device associated with the user to access a user interface comprising content recommended to the user;
selecting a set of content to recommend to the user based at least in part on the exploration score for the user and information describing a set of previous interactions by the user with the set of content;
generating the user interface comprising the selected set of content; and
sending the user interface to the client device associated with the user, wherein sending the user interface causes the client device to display the user interface.
